(19) United States
(12) Patent Application Publication
(10) Pub. No.: US 2025/0157077 A1
(43) Pub. Date: May 15, 2025

(54) IMAGE PROCESSING SYSTEM, IMAGE PROCESSING METHOD, AND NON-TRANSITORY COMPUTER-READABLE MEDIUM

(71) Applicant: NEC Corporation, Minato-ku, Tokyo (JP)

(72) Inventor: Noboru YOSHIDA, Tokyo (JP)

(73) Assignee: NEC Corporation, Minato-ku, Tokyo (JP)

(21) Appl. No.: 18/833,096

(22) PCT Filed: Feb. 9, 2022
(86) PCT No.: PCT/JP2022/005199

§ 371 Date: Jul. 25, 2024

(51) Int. Cl. G06T 7/73; G06T 7/00

(52) U.S. Cl. CPC G06T 7/74; G06T 7/0002; G06T 2207/30196; G06T 2207/30232

(57) ABSTRACT

An image processing system (10) according to the present disclosure includes: an acquisition unit (11) configured to acquire pose information based on estimation of a pose of a person included in a first image; an extraction unit (12) configured to extract, based on the pose information acquired by the acquisition unit (11), an orientation dependence-reduced feature amount in which dependence of the pose information on a pose orientation is reduced; and a setting unit (13) configured to set the orientation dependence-reduced feature amount extracted by the extraction unit (12) as a feature amount of a reference pose for detecting a state of a target person included in a second image.

### TECHNICAL FIELD

The present invention relates to an image processing system, an image processing method, and a non-transitory computer-readable medium.

### BACKGROUND ART

In recent years, a technique of detecting a state such as a pose or an action of a person from an image captured by a camera has been used. As a related art, for example, Patent Literatures 1 and 2 are known. Patent Literature 1 describes a technique of detecting a change in a pose of a person by using a temporal change in an image region of the person. Patent Literature 2 describes a technique of determining whether a pose of a person is abnormal, based on whether heights of a neck and a knee of the person from a floor satisfy a predetermined condition.

Further, Patent Literature 3 is known as a technique of retrieving an image including a similar pose from an image database. In addition, as a related art relating to skeleton estimation of a person, Non Patent Literature 1 is known.

### CITATION LIST

### Patent Literature

Patent Literature 1: Japanese Unexamined Patent Application Publication No. 2010-237873
Patent Literature 2: Japanese Unexamined Patent Application Publication No. 2021-149313
Patent Literature 3: Japanese Unexamined Patent Application Publication No. 2019-091138

### Non Patent Literature

Non Patent Literature 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pages 7291 to 7299

### SUMMARY OF INVENTION

### Technical Problem

In the related art such as Patent Literatures 1 and 2, in case where a predetermined condition is satisfied, it is possible to detect that a person is in a predetermined state. However, in the related art, it is assumed that a state of a person serving as a reference is set in advance. Therefore, in the related art, in case where it is difficult to define the state of a person to be detected, it is not possible to detect a desired person's state.

In view of such a problem, an object of the present disclosure is to provide an image processing system, an image processing method, and a non-transitory computer-readable medium that are capable of detecting a desired person's state.

### Solution to Problem

An image processing system according to the present disclosure includes: an acquisition means for acquiring pose information based on estimation of a pose of a person included in a first image; an extraction means for extracting, based on the acquired pose information, an orientation dependence-reduced feature amount in which dependence of the pose information on a pose orientation is reduced; and a setting means for setting the extracted orientation dependence-reduced feature amount as a feature amount of a reference pose for detecting a state of a target person included in a second image.

An image processing method according to the present disclosure includes: acquiring pose information based on estimation of a pose of a person included in a first image; extracting, based on the acquired pose information, an orientation dependence-reduced feature amount in which dependence of the pose information on a pose orientation is reduced; and setting the extracted orientation dependence-reduced feature amount as a feature amount of a reference pose for detecting a state of a target person included in a second image.

A non-transitory computer-readable medium storing an image processing program according to the present disclosure is a non-transitory computer-readable medium storing the image processing program for causing a computer to execute processing of: acquiring pose information based on estimation of a pose of a person included in a first image; extracting, based on the acquired pose information, an orientation dependence-reduced feature amount in which dependence of the pose information on a pose orientation is reduced; and setting the extracted orientation dependence-reduced feature amount as a feature amount of a reference pose for detecting a state of a target person included in a second image.

### Advantageous Effects of Invention

According to the present disclosure, an image processing system, an image processing method, and a non-transitory computer-readable medium that are capable of detecting a desired person's state can be provided.

### BRIEF DESCRIPTION OF DRAWINGS

FIG. 1 is a flowchart illustrating a related surveillance method;

FIG. 2 is a configuration diagram illustrating an outline of an image processing system according to example embodiments;

FIG. 3 is a configuration diagram illustrating a configuration example of an image processing apparatus according to a first example embodiment;

FIG. 4 is a flowchart illustrating an operation example of an image processing method according to the first example embodiment;

FIG. 5 is a flowchart illustrating an operation example of reference pose setting processing according to the first example embodiment;

FIG. 6 is a flowchart illustrating an operation example of state detection processing according to the first example embodiment;

FIG. 7 is a diagram illustrating a skeletal structure being used in an operation example of the image processing apparatus according to the first example embodiment;

FIG. 8 is a diagram for describing orientation normalization processing according to the first example embodiment;

FIG. 9 is a diagram for describing the orientation normalization processing according to the first example embodiment;

FIG. 10 is a diagram for describing aggregation processing according to the first example embodiment;

FIG. 11 is a diagram for describing the aggregation processing according to the first example embodiment;

FIG. 12 is a diagram for describing the aggregation processing according to the first example embodiment;

FIG. 13 is a diagram for describing the aggregation processing according to the first example embodiment;

FIG. 14 is a diagram for describing the aggregation processing according to the first example embodiment;

FIG. 15 is a diagram illustrating a display example of a state detection result according to the first example embodiment;

FIG. 16 is a configuration diagram illustrating a configuration example of an image processing apparatus according to a second example embodiment;

FIG. 17 is a flowchart illustrating an operation example of reference pose setting processing according to the second example embodiment;

FIG. 18 is a flowchart illustrating an operation example of state detection processing according to the second example embodiment;

FIG. 19 is a diagram for describing feature space mapping processing according to the second example embodiment;

FIG. 20 is a diagram for describing the feature space mapping processing according to the second example embodiment;

FIG. 21 is a diagram for describing aggregation processing according to the second example embodiment; and

FIG. 22 is a configuration diagram illustrating an outline of hardware of a computer according to the example embodiments.

### EXAMPLE EMBODIMENT

Hereinafter, example embodiments is described with reference to the drawings. In the drawings, the same element is denoted by the same reference sign, and redundant descriptions are omitted as necessary.

### Examination Leading to Example Embodiments

In recent years, image recognition techniques utilizing machine learning have been applied to various systems. As an example, a surveillance system that performs surveillance by using an image from a surveillance camera is examined.

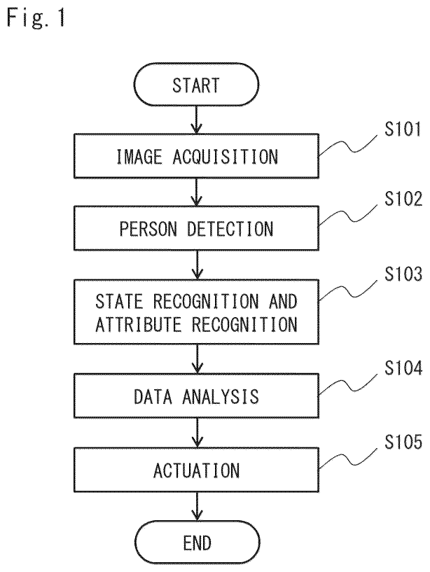

FIG. 1 illustrates a surveillance method in a related surveillance system. As illustrated in FIG. 1, a surveillance system acquires an image from a surveillance camera (S101), detects a person from the acquired image (S102), and performs state recognition and attribute recognition of the person (S103). For example, the behavior (pose, action) and the like of the person are recognized as the state of the person, and the age, sex, height, and the like of the person are recognized as the attributes of the person. In addition, in the surveillance system, data analysis is performed based on the state and attributes of the recognized person (S104), and an action such as countermeasures is performed based on the analysis result (S105). For example, an alert is displayed based on a recognized behavior or the like, and a person having an attribute such as a recognized height is surveyed.

In the state recognition in such a surveillance system, there is an increasing demand for detecting a behavior of a person, particularly a behavior different from an ordinary behavior, from a video captured by a surveillance camera. For example, such behaviors include squatting, wheelchair users, falls, etc.

The present inventors have examined a method for detecting a state such as a behavior of a person from an image, and have found a problem that, in the related art, a desired person's state may not be detected, and it is also difficult to make the detection easy. For example, an undefinable action such as an “abnormal action” cannot be detected since it is difficult to set a reference state to such action. Further, although due to the development of deep learning in recent years, it is possible to detect the above-described behavior or the like by collecting and learning a large amount of videos capturing the behavior or the like of the detection target, it is difficult to collect such learning data, and also the cost is high.

Therefore, in the present example embodiments, it becomes possible to detect even a state of a person that is difficult to define. Further, in the example embodiments, as one example, a pose estimation technique such as a skeleton estimation technique using machine learning is used for detecting a state of a person. For example, in a related skeleton estimation technique such as OpenPose disclosed in Non Patent Literature 1, a skeleton of a person is estimated by learning image data with correct answers of various patterns. In the following example embodiments, a state of a person is easily detected by utilizing such a skeleton estimation technique.

Note that, a skeleton structure estimated by a skeleton estimation technique such as OpenPose is composed of [keypoints] which are feature points such as joints, and [bones (bone links)] which indicate links between the keypoints. Therefore, in the following example embodiments, a skeleton structure is described using the terms [keypoint] and [bone], and unless otherwise limited, a [keypoint] corresponds to a [joint] of a person and a [bone] corresponds to a [bone] of a person.

### SUMMARY OF EXAMPLE EMBODIMENTS

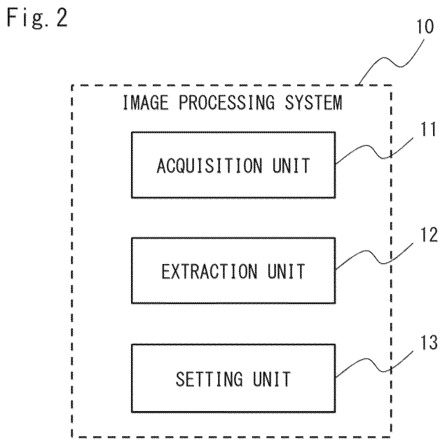

FIG. 2 illustrates an outline of an image processing system 10 according to the example embodiments. As illustrated in FIG. 2, the image processing system 10 includes an acquisition unit 11, an extraction unit 12, and a setting unit 13. Note that the image processing system 10 may be configured by a single apparatus or may be configured by a plurality of apparatuses.

The acquisition unit 11 acquires pose information based on estimation of a pose of a person included in a first image. The extraction unit 12 extracts an orientation dependence-reduced feature amount, based on the pose information acquired by the acquisition unit 11. The orientation dependence-reduced feature amount is a feature amount in which at least dependence of the orientation information (person) on a pose orientation is reduced (small), and may include a feature amount that does not depend on the pose orientation. For example, the pose orientation of the pose information may be normalized to a predetermined direction, and the feature amount of the orientation-normalized pose information may be extracted as the orientation dependence-reduced feature amount, or the pose information may be mapped to a feature space of a feature amount being invariant to the pose, and the mapped feature amount on the feature space may be extracted as the orientation dependence-reduced feature amount. It can also be said that a feature amount having a large dependence on the orientation is converted into a feature amount having a small dependence on the orientation. The setting unit 13 sets the orientation dependence-reduced feature amount extracted by the extraction unit 12 as the feature amount of the reference pose for detecting a state of a target person included in a second image. For example, detection of whether the target person is in an abnormal state is possible by using the reference pose as the pose in a normal state.

As described above, in the example embodiments, the orientation dependence-reduced feature amount in which the dependence on the pose orientation of the person is reduced is extracted by using the pose information of the person estimated from the first image, and the extracted orientation dependence-reduced feature amount is set as the feature amount of the reference pose. Thus, the reference pose can be appropriately set from the acquired pose information. Therefore, it is possible to detect a desired person's state even if such state of a person is difficult to define, according to the set reference pose. Further, by using the orientation dependence-reduced feature amount in which the dependence on the pose orientation of the person is reduced, it is possible to set the reference pose regardless of the pose orientation of the person on the image and detect the state of the person.

### First Example Embodiment

Hereinafter, a first example embodiment is described with reference to the drawings. In the present example embodiment, an example in which the orientation dependence-reduced feature amount is extracted by normalizing the orientation of the pose information is described.

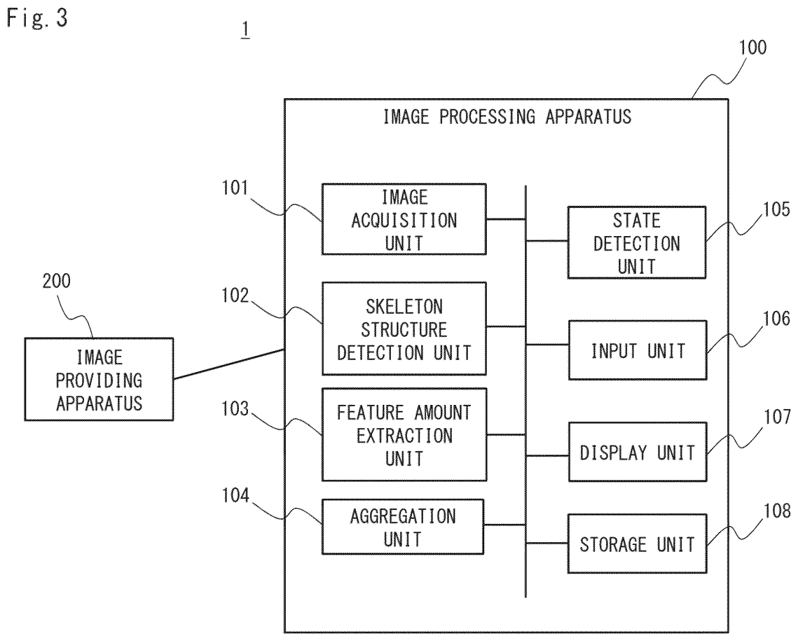

FIG. 3 illustrates a configuration example of an image processing apparatus 100 according to the present example embodiment. The image processing apparatus 100 is an apparatus configured to detect the state of a person, based on the pose of the person estimated from an image.

The image processing apparatus 100 may constitute an image processing system 1 together with an image providing apparatus 200 configured to provide an image to the image processing apparatus 100. For example, the image processing system 1 including the image processing apparatus 100 is applied to a surveillance method in a surveillance system as illustrated in FIG. 1, and detects a state of a person such as a behavior different from an ordinary state, and displays an alarm or the like in accordance with the detection.

The image providing apparatus 200 may be a camera that captures an image or an image storage apparatus in which an image is stored in advance. The image providing apparatus 200 generates (stores) a two-dimensional image including a person, and outputs the generated image to the image processing apparatus 100. The image providing apparatus 200 is directly connected or connected via a network or the like so that an image (video) can be output to the image processing apparatus 100. Note that the image providing apparatus 200 may be provided inside the image processing apparatus 100.

As illustrated in FIG. 3, the image processing apparatus 100 includes an image acquisition unit 101, a skeleton structure detection unit 102, a feature amount extraction unit 103, an aggregation unit 104, a state detection unit 105, an input unit 106, a display unit 107, and a storage unit 108. Note that, the configuration of each unit (block) is one example, and the image processing apparatus 100 may be constituted by other units as long as the operations (methods) described later can be implemented. Further, the image processing apparatus 100 is achieved by, for example, a computer device such as a personal computer or a server that executes a program, and may be achieved by a single apparatus or by a plurality of apparatuses on a network. For example, the skeleton structure detection unit 102 or the like may be provided as an external device.

The storage unit 108 stores information (data) necessary for the operation (processing) of the image processing apparatus 100. For example, the storage unit 108 is a nonvolatile memory such as a flash memory, a hard disk device, or the like. The storage unit 108 stores an image acquired by the image acquisition unit 101, an image and a detection result processed by the skeleton structure detection unit 102, data for machine learning, data aggregated by the aggregation unit 104, and the like. The storage unit 108 may be an external storage device or an external storage device on a network. That is, the image processing apparatus 100 may acquire necessary images, data for machine learning, and the like from an external storage device, or may output data of an aggregation result and the like to an external storage device.

The image acquisition unit 101 acquires an image from the image providing apparatus 200. The image acquisition unit 101 acquires a two-dimensional image (a video including a plurality of images) including a person, generated (stored) by the image providing apparatus 200. The image acquisition unit 101 can be said to include a first image acquisition unit configured to acquire a reference pose setting image (first image) at the time of setting a reference pose, and a second image acquisition unit configured to acquire a state detection target image (second image) at the time of state detection. For example, in case where the image providing apparatus 200 is a camera, the image acquisition unit 101 acquires a plurality of images (videos) including a person, captured by the camera at a predetermined aggregation period at the time of setting the reference pose or at a detection timing at the time of state detection.

The skeleton structure detection unit 102 is a pose estimation unit (pose detection unit) that estimates (detects), based on an image, a pose of a person in the image. Note that, the skeleton structure detection unit 102 may acquire, from an external device (such as the image providing apparatus 200 or the input unit 106), pose information based on estimation of the pose of the person in the image in advance. The skeleton structure detection unit 102 can be said to include a first pose estimation unit configured to estimate a pose of a person in a reference pose setting image acquired at the time of setting the reference pose, and a second pose estimation unit configured to estimate a pose of a person in the state detection target image acquired at the time of state detection.

In the present example, the skeleton structure detection unit 102 detects a skeleton structure of a person from an image as the pose of the person. Note that the pose of the person may be estimated not only by detecting the skeleton structure but also by other methods. For example, the pose of the person in the image may be estimated by using another pose estimation model trained through machine learning.

The skeleton structure detection unit 102 detects, based on the acquired two-dimensional image, a two-dimensional skeleton structure (pose information) of the person in the image. The skeleton structure detection unit 102 detects, based on a feature such as a joint of a recognized person, the skeleton structure of such person by using a skeleton estimation technique using machine learning. The skeleton structure detection unit 102 detects the skeleton structure of a recognized person in each of a plurality of images. The skeleton structure detection unit 102 may detect a skeleton structure for all persons recognized in the acquired image, or may detect a skeleton structure for a person designated in the image. The skeleton structure detection unit 102 uses, for example, a skeleton estimation technique such as OpenPose according to Non Patent Literature 1.

The feature amount extraction unit 103 extracts a feature amount of the skeleton (pose) of the person, based on the two-dimensional skeleton structure (pose information) detected from the image. The feature amount extraction unit 103 may include a first feature amount extraction unit configured to extract a feature amount of the pose of the person estimated from the reference pose setting image at the time of setting the reference pose, and a second feature amount extraction unit configured to extract a feature amount of the pose of the person estimated from the state detection target image at the time of state detection.

The feature amount extraction unit 103 extracts, as the feature amount of the skeleton structure, a feature amount (orientation dependence-reduced feature amount) in which dependence on the orientation of the skeleton (pose) of the person is reduced. In the present example embodiment, by normalizing the orientation of the skeleton structure to a predetermined reference pose direction, a feature amount in which the dependence on the orientation is reduced is extracted. The feature amount extraction unit 103 adjusts the orientation of the skeleton structure to the reference pose direction (for example, the front direction), and calculates the feature amount of the skeleton structure in a state facing the reference pose direction. The feature amount (pose feature amount) of the skeleton structure indicates the feature of the skeleton (pose) of the person, and serves as an element for detecting the state of the person, based on the skeleton of the person. The feature amount of the skeleton structure may be a feature amount of the entire skeleton structure, a feature amount of a part of the skeleton structure, or may include a plurality of feature amounts as in each part of the skeleton structure. For example, the feature amount of the skeleton structure may include a position, a size, a direction, and the like of each part included in the skeleton structure.

Further, the feature amount extraction unit 103 may normalize the calculated feature amount with other parameters. For example, a height of a person, a size of a skeleton region, or the like may be used as a normalization parameter. For example, the feature amount extraction unit 103 calculates the height (the number of height pixels) of the person in the two-dimensional image when the person stands upright, and normalizes the skeleton structure of the person, based on the calculated number of height pixels of the person. The number of height pixels is the height of the person in the two-dimensional image (the length of the whole body of the person in the two-dimensional image space). The feature amount extraction unit 103 acquires the number of height pixels (the number of pixels) from the length (the length in the two-dimensional image space) of each bone of the detected skeleton structure.

For example, the feature amount extraction unit 103 may normalize the position of each keypoint (feature point) included in the skeleton structure on the image as a feature amount by the number of height pixels. The position of the keypoint can be determined from the values (number of pixels) of the X-coordinate and the Y-coordinate of the keypoint. The height direction which defines the Y-coordinate may be a direction of a vertical projection axis (vertical projection direction) formed by projecting a direction of a vertical axis perpendicular to the ground (reference plane) in a three-dimensional coordinate space of the real world onto the two-dimensional coordinate space. In such a case, the height of the Y-coordinate can be found from a value (number of pixels) along a vertical projection axis which is acquired by projecting an axis perpendicular to the ground in the real world onto a two-dimensional coordinate space based on camera parameters. Note that, the camera parameter is an imaging parameter of an image, and, for example, the camera parameter is a pose, a position, an imaging angle, a focal length, or the like of the camera. By means of the camera, an object the length and position of which are known in advance can be imaged and camera parameters can be determined from the image.

The aggregation unit 104 aggregates the extracted plurality of feature amounts (orientation dependence-reduced feature amounts) of the skeleton structures (postures), and sets the aggregated feature amounts as the feature amounts of the reference pose. Note that the feature amount of the reference pose may be set based on the extracted single feature amount of the skeleton structure. The aggregation unit 104 can also be said to be a setting unit configured to set the reference pose, based on the pose of the person extracted from the reference pose setting image at the time of setting the reference pose. The reference pose is a pose serving as a reference for detecting a state of a person, and is, for example, a pose of a person in a normal state (an ordinary state).

The aggregation unit 104 aggregates a plurality of feature amounts of skeleton structures in a plurality of images captured in a predetermined aggregation period at a time when the reference pose is set. For example, the aggregation unit 104 calculates an average value of the plurality of feature amounts, and sets the average value as the feature amount of the reference pose. That is, the aggregation unit 104 calculates an average value of feature amounts of all or a part of the plurality of skeleton structures aligned in the reference pose direction. In addition, other statistical values such as variance and intermediate values may be calculated instead of the average of the skeleton structures. For example, the calculated statistical value such as a variance may be used as a parameter (weight) for determining the similarity degree at the time of state detection.

The aggregation unit 104 stores, in the storage unit 108, the feature amount of the reference pose in which the feature amount is aggregated and set. The aggregation unit 104 aggregates the feature amounts of the skeleton structure for each predetermined unit. The aggregation unit 104 may aggregate the feature amount of the skeleton structure of the person in a single image, or may aggregate the feature amount of the skeleton structure of the person in a plurality of images. Further, the aggregation unit 104 may aggregate the feature amounts for each predetermined region (location) in the image. The aggregation unit 104 may aggregate the feature amounts for each predetermined time period in which an image is captured.

The state detection unit 105 detects the state of the person to be detected included in the image, based on the set feature amount of the reference pose. The state detection unit 105 detects the state of the pose of the person extracted from the state detection target image at the time of state detection. The state detection unit 105 compares the feature amount of the reference pose stored in the storage unit 108 with the feature amount of the pose of the person to be detected, and detects the state of the person, based on the comparison result.

The state detection unit 105 calculates the similarity degree between the feature amount of the reference pose and the feature amount (orientation dependence-reduced feature amount) of the pose (skeleton structure) of the target person, and determines the state of the target person, based on the calculated similarity degree. The state detection unit 105 is also a similarity degree determination unit configured to determine the similarity degree between the feature amount of the reference pose and the feature amount of the pose of the target person. The similarity degree between the feature amounts is the distance between the feature amounts. The state detection unit 105 determines that the target person is in a normal state in case where the similarity degree is higher than a predetermined threshold value, and determines that the target person is in an abnormal state in case where the similarity degree is lower than the predetermined threshold value. Note that not only the normal state and the abnormal state but also a plurality of states may be detected. For example, a reference pose may be prepared for each of a plurality of states, and a state of the closest reference pose may be selected.

In case where determining the similarity degree of the poses, the state detection unit 105 may determine the similarity degree of the feature amount of the entire skeleton structure, or may determine the similarity degree of the feature amount of a part of the skeleton structure. For example, the similarity degree of the feature amounts of the first parts (e.g., both hands) and the second parts (e.g., both feet) of the skeleton structures may be determined. Further, the similarity degree may be acquired based on the weights set in each parts of the reference pose (skeleton structure). Furthermore, the similarity degree between a plurality of feature amounts of the reference pose and a plurality of feature amounts of the pose of the target person may be acquired.

Note that the state detection unit 105 may detect the state of the person, based on the feature amount of the pose in each image, or may detect the state of the person, based on a change in the feature amounts of the pose in a plurality of images (videos) consecutive in time series. That is, a reference action including a time-series reference pose may be set from not only the image but also the acquired video, and the state (action) of the person may be detected, based on the similarity degree between the action including the time-series pose of the target person and the reference action. In such a case, the state detection unit 105 detects the similarity degree of the feature amounts in units of frames (images). For example, keyframes may be extracted from a plurality of frames, and the similarity degree may be determined by using the extracted keyframes.

The input unit 106 is an input interface for acquiring information input from a user operating the image processing apparatus 100. The input unit 106 is, for example, a graphical user interface (GUI), and receives input of information according to the operation by the user from an input device such as a keyboard, a mouse, or a touch panel. For example, the input unit 106 may accept the pose of the designated person as the pose for setting the reference pose from among the plurality of images. Further, the user may manually input the pose (skeleton) of the person for setting the reference pose.

The display unit 107 is a display unit configured to display the result of operation (processing) and the like of the image processing apparatus 100, and is, for example, a display apparatus such as a liquid crystal display or an organic electroluminescence (EL) display. The display unit 107 displays the processing results of the respective units, such as the detection results of the state detection unit 105, on the GUI.

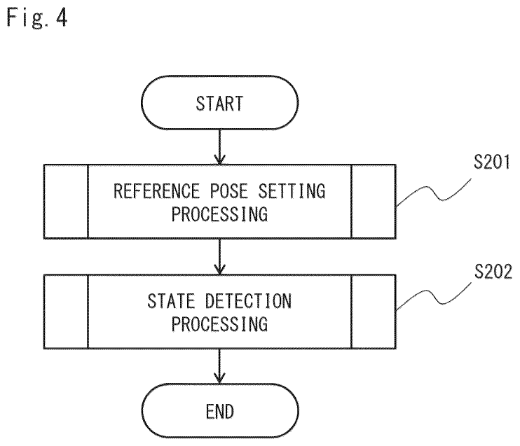

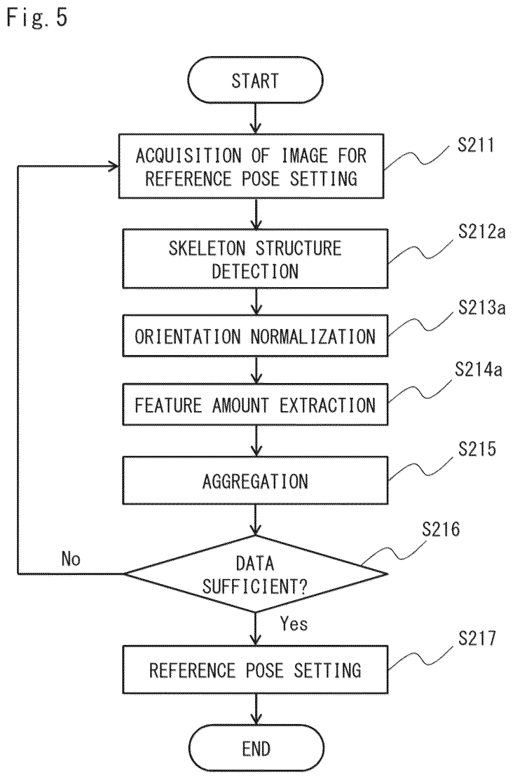

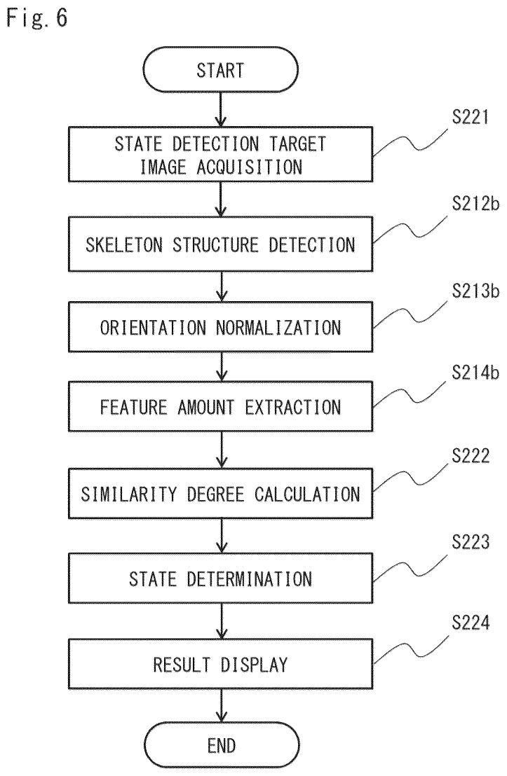

FIGS. 4 to 6 illustrate an operation (image processing method) of the image processing apparatus 100 according to the present example embodiment. FIG. 4 illustrates the flow of the overall operation of the image processing apparatus 100, FIG. 5 illustrates the flow of reference pose setting processing (S201) in FIG. 4, and FIG. 6 illustrates the flow of state detection processing (S202) in FIG. 4.

As illustrated in FIG. 4, the image processing apparatus 100 performs the reference pose setting processing (S201) and then performs the state detection processing (S202). For example, the image processing apparatus 100 sets the feature amount of the pose in the normal state by performing the reference pose setting processing by using an image (reference pose setting image) captured during a predetermined aggregation period (a period until necessary data is aggregated) at the time of reference pose setting. The image processing apparatus 100 detects a state of a person to be detected by performing state detection processing by using an image (state detection target image) captured at a detection timing (or detection period) at the time of subsequent state detection.

First, in the reference pose setting processing (S201), as illustrated in FIG. 5, the image processing apparatus 100 acquires a reference pose setting image (S211). The image acquisition unit 101 acquires the reference pose setting image including the pose of the person for setting the reference pose to be the pose of the normal state. The image acquisition unit 101 may acquire one or more images captured in a predetermined period from the camera as the reference pose setting image, or may acquire one or more images stored in the storage device. Subsequent processing is performed on the acquired one or more images.

Note that the user may input (select) the reference pose setting image or input (select) the pose of the person for reference pose setting. For example, a plurality of images may be displayed on the display unit 107, and the user may select, for setting the reference pose, an image including the pose of the person or may select a person (pose) in the image. For example, the skeleton of the person of the pose estimation result may be displayed in each image, and the image or the person may be selectable. The user may select a plurality of images or a plurality of poses of a person for the reference pose setting. For example, a pose in which a person stands upright and a pose in which a person is talking on a phone may be set as the reference pose.

In addition, the user may input the pose (skeleton) of the person to be set as the reference pose by other methods, not limited to the image. For example, the pose may be input by moving each part of the skeleton structure in accordance with the user's operation. In case where the skeleton structure is input, pose estimation processing (S212a) may be omitted. In addition, in accordance with the user's input, a weight (for example, 0 to 1) may be set to a portion to be focused among the skeleton being the reference pose. Further, a pair of a label, such as standing upright, squatting, or sleeping, and a pose (skeleton) may be prepared (stored), and the user may select a pair of label and pose therefrom to input a pose to be set as a reference pose.

Subsequently, the image processing apparatus 100 detects the skeleton structure of the person, based on the acquired reference pose setting image (S212a). For example, the acquired reference pose setting image includes a plurality of persons, and the skeleton structure detection unit 102 detects the skeleton structure as the pose of the person for each person included in the image.

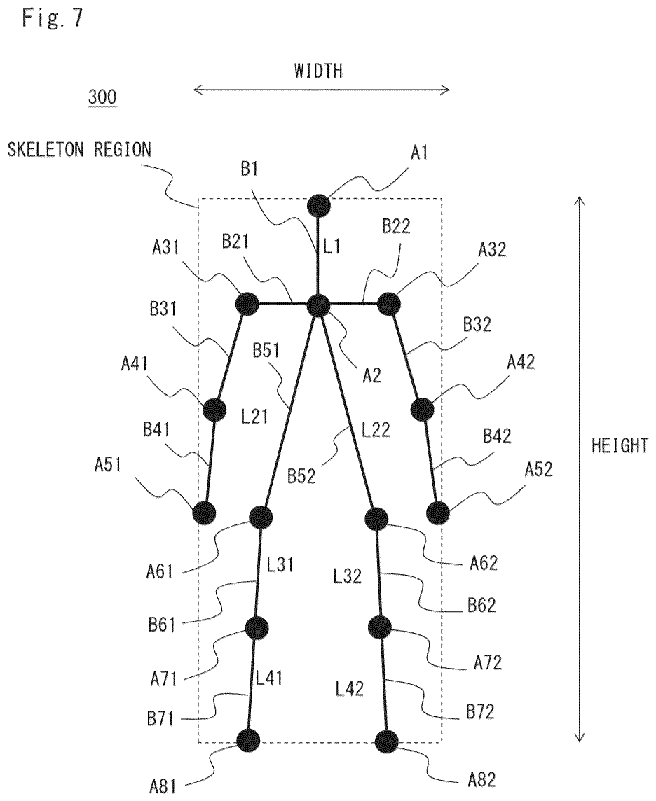

FIG. 7 illustrates a skeleton structure of a human body model 300 detected at this time. The skeleton structure detection unit 102 detects the skeleton structure of the human body model (two-dimensional skeleton model) 300 as illustrated in FIG. 7 from the two-dimensional image, using a skeleton estimation technique such as OpenPose. The human body model 300 is a two-dimensional model configured of keypoints such as a joint of a person and bones connecting the keypoints.

For example, the skeleton structure detection unit 102 extracts feature points that may be keypoints from the image, and detects each keypoint of the person with reference to information acquired through machine learning using the image of the keypoint. In the example of FIG. 7, the head A1, the neck A2, the right shoulder A31, the left shoulder A32, the right elbow A41, the left elbow A42, the right hand A51, the left hand A52, the right waist A61, the left waist A62, the right knee A71, the left knee A72, the right foot A81, and the left foot A82 are detected as keypoints of the person. Further, as bones of the person connecting each of the keypoints, a bone B1 connecting the head A1 and the neck A2, a bone B21 connecting the neck A2 and the right shoulder A31 and a bone B22 connecting the neck A2 and the left shoulder A32, a bone B31 connecting the right shoulder A31 and the right elbow A41 and a bone B32 connecting the left shoulder A32 and the left elbow A42, a bone B41 connecting the right elbow A41 and the right hand A51 and a bone B42 connecting the left elbow A42 and the left hand A52, a bone B51 connecting the neck A2 and the right waist A61 and a bone B52 connecting the neck A2 and the left waist A62, a bone B61 connecting the right waist A61 and the right knee A71 and a bone B62 connecting the left waist A62 and the left knee A72, and a bone B71 connecting the right knee A71 and the right foot A81 and a bone B72 connecting the left knee A72 and the left foot A82 are detected.

Subsequently, the image processing apparatus 100 normalizes the orientation of the detected skeleton structure of the person (S213a). The feature extraction unit 103 adjusts the orientation of the skeleton structure to the reference pose direction (for example, the front direction), and normalizes the orientation of the skeleton structure. The feature extraction unit 103 detects the front, rear, left, and right of the person from the detected skeleton structure, and extracts the front direction of the skeleton structure in the image as the orientation of the skeleton structure. The feature extraction unit 103 rotates the skeleton structure in such a way that the orientation of the skeleton structure matches the reference pose direction. The rotation of the skeleton structure may be performed on a two-dimensional plane or in a three-dimensional space.

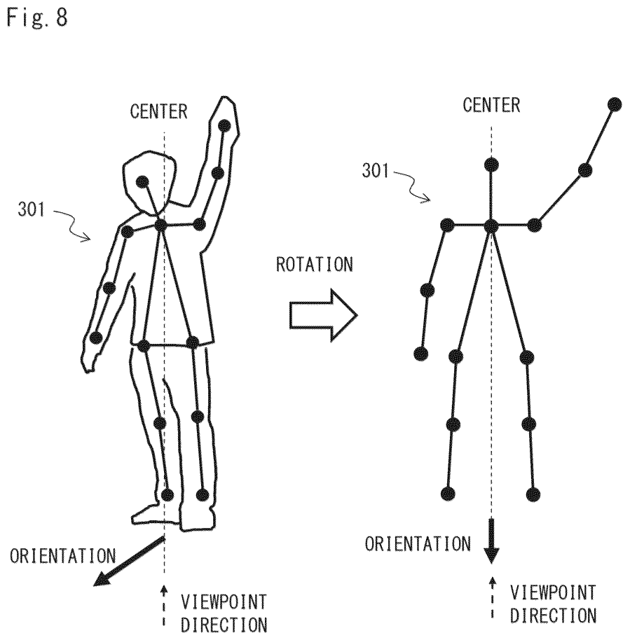

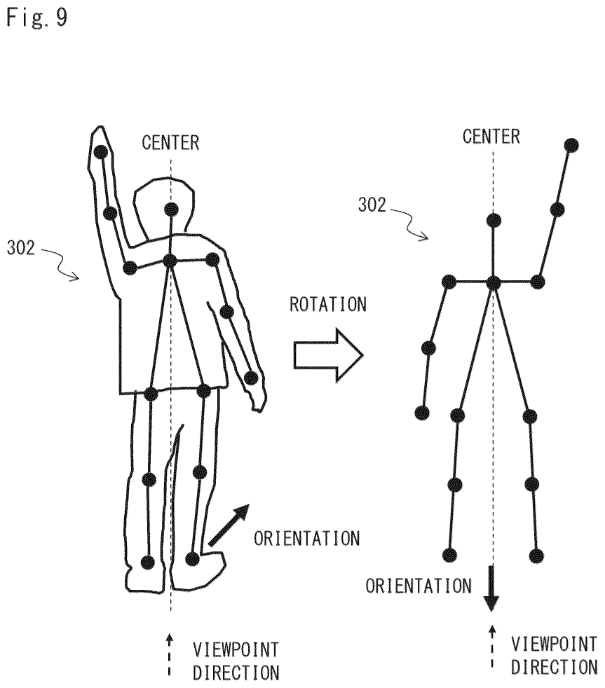

FIGS. 8 and 9 illustrate examples of normalizing the orientation of the skeleton structure. FIG. 8 is an example of using an image acquired by capturing a person standing with his/her left hand raised from diagonally front to the left. For example, the orientation of the person can be extracted by using the coordinates of each part on the right side and the coordinates of each part on the left side with the axis in the height direction from the neck or the head as the central axis of the human body model (skeleton structure). In such a case, when the orientation is extracted based on a human body model 301 detected from the image, the orientation of the person on the two-dimensional image is an orientation in the left front side (lower left side) relative to the captured viewpoint direction (imaging direction). Therefore, the feature extraction unit 103 rotates the human body model 301 in such a way that the human body model 301 facing the left front side is oriented in the front direction parallel to the viewpoint direction. For example, the angle between the orientation of the human body model 301 and the viewpoint direction is acquired, and the human body model 301 is rotated by the acquired angle by using the center axis of the human body model 301 as a rotation axis. In case where the center axis of the human body model 301 is inclined with respect to the vertical direction on the two-dimensional image, the inclination is adjusted so that the center axis of the human body model 301 matches the vertical direction on the two-dimensional image. As a result, a human body model 301 (skeleton structure) of a person with his/her left hand raised viewed from the front on the two-dimensional image is gained.

FIG. 9 is an example of using an image acquired by capturing a person standing with his/her left hand raised from diagonally behind the right. In such a case, when the orientation is extracted based on a human body model 302 detected from the image, the orientation of the person on the two-dimensional image is an orientation in the right rear side (upper right side) relative to the captured viewpoint direction (imaging direction). Therefore, the feature extraction unit 103 rotates the human body model 302 in such a way that the orientation of the human body model 302 facing the right rear side is oriented in the front direction parallel to the viewpoint direction. As a result, similarly to FIG. 8, the human body model 302 (skeleton structure) of a person with his/her left hand raised is viewed from the front on the two-dimensional image is gained.

Subsequently, the image processing apparatus 100 extracts the feature amount of the skeleton structure of the person the orientation of which is normalized (S214a). The feature amount extraction unit 103 extracts, as the feature amount of the skeleton structure, for example, keypoint positions being positions of all the keypoints included in the detected skeleton structure. The keypoint position can also be said to indicate the size and direction of a bone specified by the keypoint. The keypoint position can be determined from the X- and Y-coordinates of the keypoint in the two-dimensional image. The keypoint position is a relative position of the keypoint to the reference point, and includes a position (the number of pixels) in the height direction and a position (the number of pixels) in the width direction of the keypoint relative to the reference point. As o example, the keypoint position may be acquired from the Y-coordinate and the X-coordinate of the reference point and the Y-coordinate and the X-coordinate of the keypoint in the image. The difference between the Y-coordinate of the reference point and the Y-coordinate of the keypoint is the position in the height direction, and the difference between the X-coordinate of the reference point and the X-coordinate of the keypoint is the position in the width direction.

The reference point is a point being a reference for representing the relative position of the keypoint. The position of the reference point in the skeleton structure may be set in advance or may be selected by the user. The reference point is preferably the center of the skeleton structure or at a position higher (in the image, up in the up-down direction) than the center, and, for example, the coordinates of the keypoint of the neck may be used as the reference point. The reference point is not limited to the keypoint of the neck, and coordinates of keypoints of the head and other parts may be used as the reference point. The reference point is not limited to the keypoint, and may be any coordinate (for example, the center coordinates of the skeleton structure or the like).

Further, in case where the feature amount is normalized, for example, the feature amount extraction unit 103 calculates a normalization parameter such as the number of height pixels, based on the detected skeleton structure. The feature amount extraction unit 103 normalizes feature amounts such as keypoint positions by the number of height pixels or the like. For example, the number of height pixels, being the height of the skeleton structure of the person in an upright position in the image, and the keypoint positions of the keypoints of the skeleton structure of the person in the image are determined. The number of height pixels may be determined by summing the lengths of the bones from the head part to the foot part among the bones of the skeleton structure. In a case where the skeleton structure detection unit 102 does not output the top of the head and around the foot, correction may be performed by multiplying by a constant as necessary.

Specifically, the feature amount extraction unit 103 acquires the lengths of the bones on the two-dimensional image from the head part to the foot part of the person, and calculates the number of height pixels. For example, the lengths (the number of pixels) of the bone B1 (length L1), the bone B51 (length L21), the bone B61 (length L31), and the bone B71 (length L41), or the bone B1 (length L1), the bone B52 (length L22), the bone B62 (length L32), and the bone B72 (length L42) among the bones in FIG. 7 are acquired. The length of each bone can be determined from the coordinates of each keypoint in the two-dimensional image. A value calculated by multiplying the sum of the above-described lengths, i.e. L1+L21+L31+L41 or L1+L22+L32+L42, by a correction constant is calculated as the number of height pixels. In a case where both values can be calculated, for example, the longer value is set as the number of height pixels. That is, in case where each bone is captured from the front, the length thereof in the image becomes the longest, and in case where the bone is tilted in the depth direction relative to the camera, the bone is displayed short. Therefore, it is highly likely that a long bone is imaged from the front, and it is considered to be close to the true value. Therefore, it is preferable to select the longer value.

Note that the number of height pixels may be calculated by other calculation methods. For example, an average human body model indicating a relationship (ratio) between the length of each bone and the height in the two-dimensional image space may be prepared in advance, and the number of height pixels may be calculated from the length of each bone detected using the prepared human body model.

In case where normalizing each keypoint position by the number of height pixels, the feature amount extraction unit 103 divides each keypoint position (X-coordinate and Y-coordinate) by the number of height pixels, and sets the result as a normalized value.

Further, the height (the number of pixels) and the area (the pixel area) of the skeleton region may be used as the normalization parameter. In the example of FIG. 7, a skeleton region including all bones is extracted from a skeleton structure of a person standing upright. In such a case, the upper end of the skeleton region is the keypoint A1 of the head part, the lower end of the skeleton region is the keypoint A81 of the right foot or the keypoint A82 of the left foot, the left end of the skeleton region is the keypoint A51 of the right hand, and the right end of the skeleton region is the keypoint A52 of the left hand. Therefore, the height of the skeleton region is determined from the difference between the Y-coordinates of the keypoint A1 and the keypoint A81 or A82. Further, the width of the skeleton region is determined from the difference between the X-coordinates of the keypoint A51 and the keypoint A52, and the area is determined from the height and the width of the skeleton region. For example, each keypoint position may be divided by the height, width, area, or the like of the skeleton region and set as a normalized value.

Subsequently, the image processing apparatus 100 aggregates the extracted plurality of feature amounts of the skeleton structure (S215). Until sufficient data is acquired (S216), the image processing apparatus 100 repeats the processing from the image acquisition to the aggregation of the feature amount of the skeleton structure (S211 to S215), and then sets the aggregated feature amount as the feature amount of the reference pose (S217).

The aggregation unit 104 aggregates a plurality of feature amounts of skeleton structures extracted from a single image or from a plurality of images. In case where the keypoint position is determined as the feature amount of the skeleton structure, the aggregation unit 104 aggregates the keypoint position for each keypoint. For example, the aggregation unit 104 calculates a statistical value such as an average or variance of the plurality of feature amounts of the skeleton structures for each predetermined unit, and sets the feature amount of the skeleton structure (average pose or frequent pose) based on the determined statistical value as the feature amount of the reference pose. The aggregation unit 104 stores the set feature amount of the reference pose in the storage unit 108.

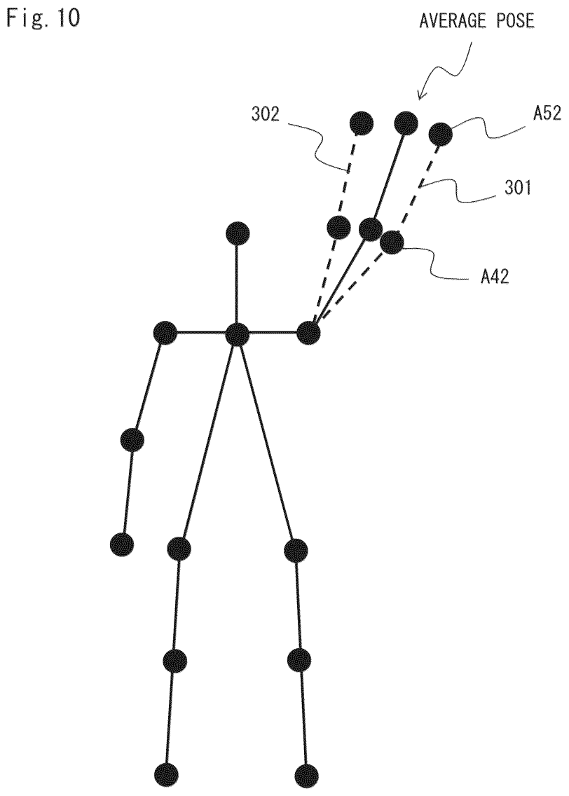

FIG. 10 illustrates an example in which an average pose is acquired from feature amounts of a plurality of skeleton structures, and a reference pose is set. In the example of FIG. 10, the human body models 301 and 302 are skeleton structures of a person standing with his/her left hand raised, in which the positions of the left hands in the human body models 301 and 302 are shifted. The aggregation unit 104 calculates an average of each keypoint position of the human body model 301 and each keypoint position of the human body model 302. For example, the coordinates between the keypoint A52 of the left hand of the human body model 301 and the keypoint A52 of the left hand of the human body model 302 are the average values of the keypoint A52. The coordinates between the left elbow keypoint A42 of the human body model 301 and the left elbow keypoint A42 of the human body model 301 are the average values of the keypoint A42. The aggregation unit 104 sets the skeleton structure of the keypoint position of the acquired average value as the average pose, and sets such average pose as the reference pose.

Further, not only an average pose but also a frequent pose may be set as the reference pose. As an example of setting the frequent pose, for example, a plurality of feature amounts of a skeleton structure may be clustered for each predetermined unit, and the feature amounts of the reference pose may be set based on the clustered result. In such a case, the plurality of feature amounts of the skeleton structure are clustered, and the feature amount (average or the like) included in any of the clusters is set as the feature amount of the reference pose. The pose of the cluster including the largest feature amount (pose information) among the plurality of clusters may be set to the reference pose as the frequent pose.

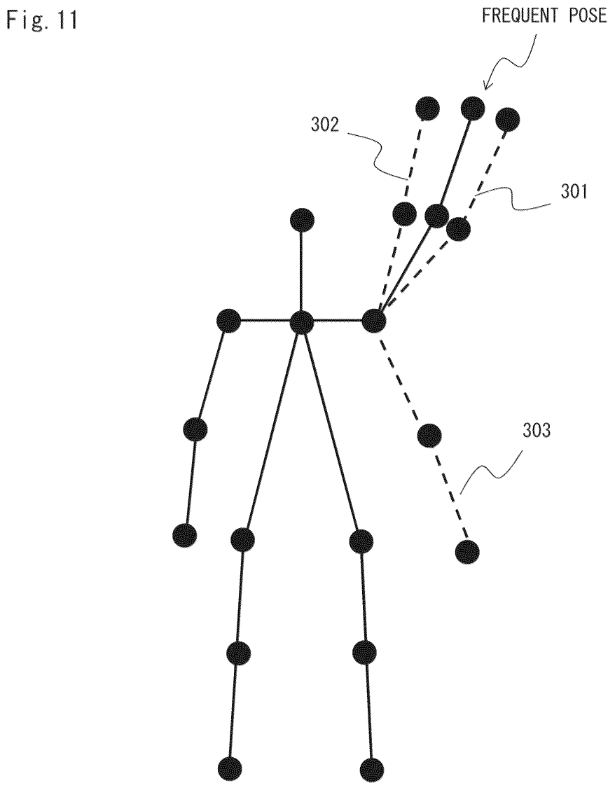

FIG. 11 illustrates an example in which a frequent pose is acquired from a plurality of feature amounts of a skeleton structure, and the frequent pose is set to a reference pose. In the example of FIG. 11, the human body models 301 and 302 are skeleton structures of a person standing with his/her left hand raised, and a human body model 303 is a skeleton structure of a person standing with his/her left hand lowered. The aggregation unit 104 performs classification (clustering) in such a way that similar poses are classified into the same cluster. For example, the human body models 301 and 302 are included in a first cluster, and the human body model 303 is included in a second cluster. Since the first cluster has a larger volume of data of the feature amount than the second cluster, for example, the average of the feature amounts included in the first cluster is set as the feature amount of the reference pose.

In case where aggregating the feature amount of the entire image, the aggregation unit 104 sets a reference pose for the image, based on the aggregated feature amount. In addition, in case where the feature amount is aggregated for each location of the image, the aggregation unit 104 sets a reference pose for each location of the image, based on the aggregated feature amount. In such a case, the aggregation unit 104 divides the image into a plurality of aggregation regions, aggregates the feature amount of the skeleton structure for each aggregation region, and sets each aggregation result as the feature amount of the reference pose of each aggregation region. The aggregation region may be a predetermined region, or may be a region designated by the user.

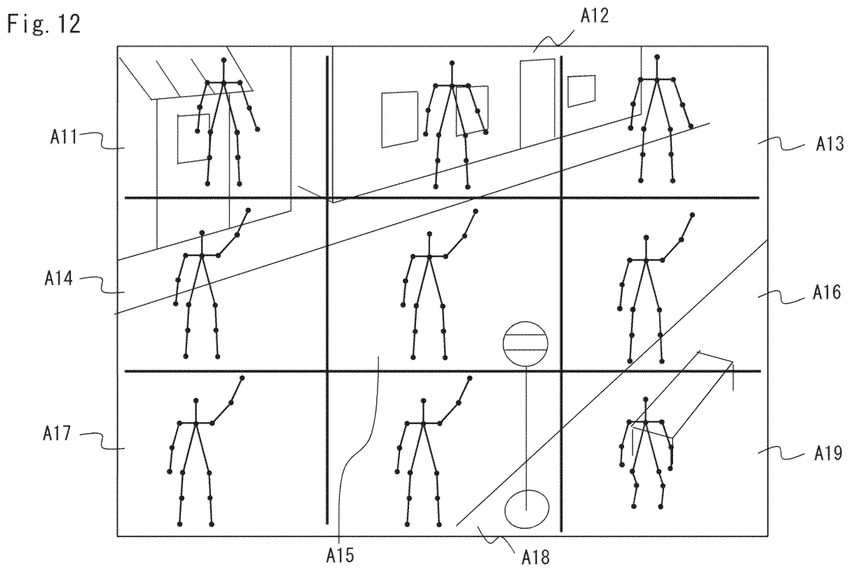

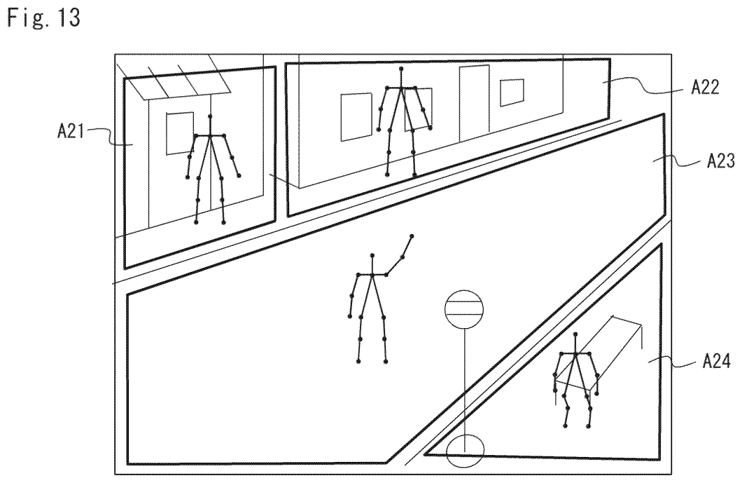

FIGS. 12 and 13 illustrate examples of aggregating feature amounts of the skeleton structure for each aggregation regions. In the example of FIG. 12, the aggregation region is a rectangular area (A11 to A19) defined by dividing the image at predetermined intervals in the vertical direction and the horizontal direction. The aggregation region is not limited to a rectangular shape, and may be any shape. For example, the aggregation region is divided at predetermined intervals without considering the background of the image. Note that, the aggregation region may be divided in consideration of the background of the image, the amount of aggregation data, and the like. For example, a region farther from the camera (upper side of the image) may be made smaller than a region closer to the camera (lower side of the image), according to the imaging distance so as to be associated with the relationship between the size in the image and the real world. In addition, a region having a larger feature amount may be made smaller than a region having a smaller feature amount in accordance with the amount of data to be aggregated. In the example of FIG. 12, as a result of aggregation in each rectangular region, in a rectangular region (A14 to A18) including a road, a standing pose with the right hand raised is set as a reference pose, in a rectangular region (A11 to A13) including a building, a standing pose with both hands lowered is set as a reference pose, and in a rectangular region (A19) including a chair, a sitting pose is set as a reference pose.

Further, in the example of FIG. 13, the aggregation region is a region formed by dividing an image in accordance with a background (scene). In the present example, the image is divided into a region (A23) of a road, regions (A21, A22) near a building, and a region (A24) near a chair of a bus stop. Each region may be set by the user according to the background, or each region may be automatically set by performing image recognition of an object or the like in the image. In the example of FIG. 13, as a result of aggregation in each region, in the region (A23) of the road, a standing pose with the right hand raised is set as a reference pose, in the regions (A21, A22) near the building, a standing pose with both hands lowered is set as a reference pose, and in the region (A24) near the chair, a sitting pose is set as a reference pose.

For example, the aggregation unit 104 aggregates, for each aggregation region, a feature amount of a person whose foot (for example, the lower end of the foot) is detected in the aggregation region. In case where a part other than the foot is detected, the part other than the foot may be used as a criterion for aggregation. For example, the feature amount of a person whose head or torso is detected in the aggregation region may be aggregated for each aggregation region. The aggregation unit 104 acquires the average pose and the frequent pose for each of the aggregation regions as described above, and sets the feature amount of the reference pose.

By aggregating feature amounts of more skeleton structures for each aggregation region, it is possible to improve the setting accuracy of the normal state and the detection accuracy of the person. For example, it is preferable to aggregate three to five feature amounts for each aggregation region and calculate an average. By calculating the average of the plurality of feature amounts, it is possible to acquire data of a normal state in the aggregation region. Although the detection accuracy can be improved by increasing the aggregation region and the aggregation data, the detection process requires time and cost. although detection may be executed easily by reducing the aggregation region and the aggregation data, the detection accuracy may be lowered. Therefore, it is preferable to determine the number of the aggregation regions and the aggregation data in consideration of the required detection accuracy and the cost.

In addition, in case where aggregating the feature amount for each time period, the aggregation unit 104 sets a reference pose for each time period, based on the aggregated feature amount. The image-captured time is set in each of the acquired images, and the period in which all the images are captured is divided into a plurality of aggregation time periods. The aggregation unit 104 aggregates the feature amounts of the skeleton structures of the plurality of images included in the time period for each aggregation time period, and sets each aggregation result as the feature amount of the reference pose of each aggregation time period. The aggregation time period may be a predetermined time period or may be a time period designated by the user. Each aggregation time period may be a time period of the same length or a time period of different lengths. The aggregation time period may be divided in consideration of the time of the event related to the action of the person, the amount of the aggregated data, and the like. The time period in which the feature amount is larger may be shortened than the time period in which the feature amount is smaller according to the amount of data to be aggregated. The aggregation unit 104 acquires the average pose and the frequent pose as described above for each time period, and sets the feature amount of the reference pose. Further, in each time period, the reference pose may be set by aggregating for each aggregation region as described above.

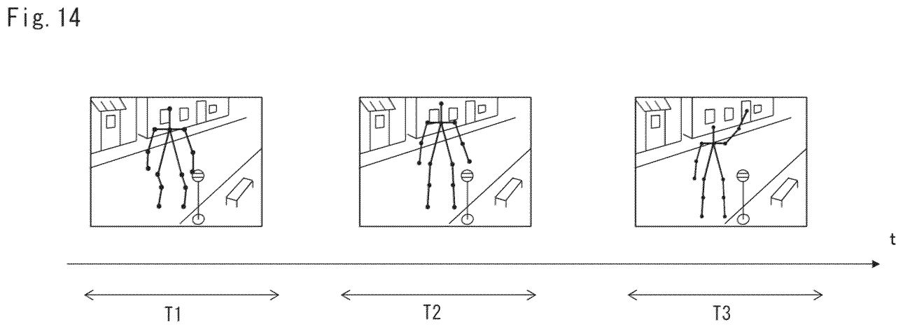

FIG. 14 illustrates an example in which feature amounts of the skeleton structure are aggregated for each time period. In the example of FIG. 14, the entire period is divided into aggregation time periods T1 to T3. In FIG. 14, the period is divided into the time period (T1) until a bus arrives at a bus stop, the time period (T2) when the bus is at the bus stop, and the time period (T3) after the bus stop departs. For example, as a result of aggregation in each time period, in the time period (T1) until the bus arrives at the bus stop, a pose seated in a chair is set as the reference pose, in the time period (T2) when the bus is at the bus stop, a pose standing with both hands lowered is set as the reference pose, and in the time period (T3) after the bus stop departs, a pose standing with the right hand raised is set as the reference pose.

Next, in the state detection process (S202), as illustrated in FIG. 6, the image processing apparatus 100 acquires the state detection target image (S221). The image acquisition unit 101 acquires an image acquired by capturing a person to be detected in order to detect a state (pose) of the person to be detected. The image acquisition unit 101 may acquire one or more images captured in a predetermined period from the camera or may acquire one or more images stored in the storage device as the state detection target. Subsequent processing is performed on the acquired one or more images.

The user may input (select) the state detection target image, or may input (select) the person (pose) of the state detection target. For example, a plurality of images may be displayed on the display unit 107, and the user may select an image including a pose of a person or may select a person (pose) in the image as a state detection target. For example, the skeleton of the person of the pose estimation result may be displayed in each image, and the image or the person may be made selectable. The user may select a plurality of images or a plurality of persons as the state detection target.

When the state detection target image is input, the image processing apparatus 100 performs detection (S212b), orientation normalization (S213b), and feature amount extraction (S214b) of the skeleton structure of the person of the state detection target image similarly to the case of setting the reference pose. That is, the skeleton structure detection unit 102 detects a skeleton structure of a person (a person designated as a detection target) in the state detection target image. The feature amount extraction unit 103 normalizes the direction of the detected skeleton structure, and extracts the feature amount of the skeleton structure in which the direction is normalized.

Subsequently, the image processing apparatus 100 calculates the similarity degree between the reference pose and the pose of the target person (S222), and determines the state of the target person, based on the similarity degree (S223). The state detection unit 105 determines whether the extracted pose (skeleton structure) of the person to be detected is close to the set reference pose by using the similarity degree of the feature amount, determines that the person to be detected is in a normal state in case where the pose is close to the reference pose, and determines that the person to be detected is in an abnormal state in case where the pose is far from the reference pose.

Specifically, the state detection unit 105 calculates the similarity degree between the feature amount of the reference pose stored in the storage unit 108 in S217 and the feature amount of the pose (skeleton structure) of the target person extracted in S214b. For example, the state detection unit 105 calculates a distance (difference) between each part (keypoint or bone) of the reference pose and each part of the pose of the target person in the two-dimensional image space. In case where the keypoint position is acquired as the feature amount of the skeleton structure, the distance of the keypoint position of each part is calculated. The state detection unit 105 calculates the similarity degree in such a way that the smaller the total value of the distances of the parts, the higher the similarity degree, and the larger the total value of the distances of the parts, the smaller the similarity degree.

For example, the state detection unit 105 calculates the similarity degree of the poses of the plurality of target persons, determines that a target person in a pose in which the similarity degree is larger than the threshold is in a normal state, and determines that a target person in a pose in which the similarity degree is smaller than the threshold is in an abnormal state. A possibility (probability) of the person being determined as being in a normal state or in an abnormal state may be calculated according to the similarity degree of the feature amounts. In case where the reference pose and the pose of the target person include a plurality of poses, the similarity degree for each pose may be calculated, and the state of the target person may be determined based on the total value of the plurality of similarity degrees.

In a case where a weight is set for each part of the reference pose, the state detection unit 105 may calculate the similarity degree, based on the weight of each part. The weight of each part may be set by the user at the time of inputting the reference pose, or may be set according to the distribution of the aggregation result of the reference pose setting, or the like. For example, the state detection unit 105 multiplies the difference between each portions by the weight of each portions, and calculates the similarity degree, based on the total value of the multiplied values.

In a case where a reference pose is set for each aggregation region, the state detection unit 105 may calculate the similarity degree between the feature amount of the pose of the person to be detected and the feature amount of the reference pose set in an aggregation region associated with the detection target. For example, an aggregation region including the foot of the person to be detected is recognized, and the similarity degree between the feature amount of the reference pose in the recognized aggregation region and the feature amount of the pose of the person to be detected is calculated.

In a case where a reference pose is set for each time period, the state detection unit 105 may calculate the similarity degree between the feature amount of the pose of the person to be detected and the feature amount of the reference pose set in a time period associated with the detection target. For example, the time point when the pose of the person to be detected is captured is acquired from the state detection target image, and the similarity degree between the feature amount of the reference pose in the time period associated with the acquired time point and the feature amount of the pose of the person to be detected is calculated.

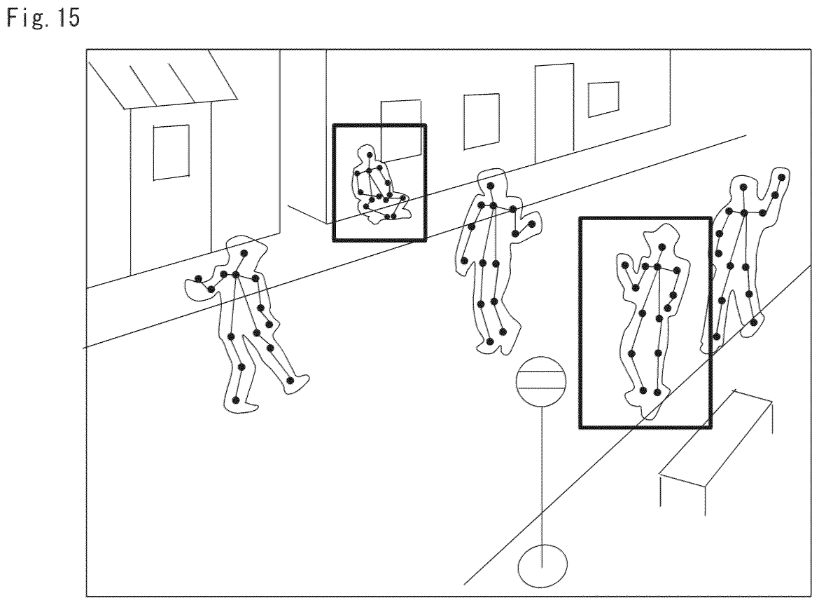

Subsequently, the image processing apparatus 100 displays the determination result of the state of the person (S224). The display unit 107 displays the state detection target image and displays the state of the person detected in the state detection target image. FIG. 15 illustrates a display example of a state of a person displayed on the display unit 107. For example, poses (skeleton structures) of the persons in the image is displayed, and a pose of a person determined to be in an abnormal state is highlighted. In the example of FIG. 15, a rectangle is displayed around a pose of a person which has a low similarity degree with the reference pose and which is determined to be abnormal. The way of highlighting is not limited to displaying a rectangle, and a calculated similarity degree with the reference pose may be displayed, or the display mode of the pose of the person may be changed according to the similarity degree. The pose of the person may be displayed so as to be emphasized as the similarity degree decreases. Further, the similarity degree of the reference pose may be displayed for each part of the skeleton structure, or the display mode of each part of the pose of the person may be changed according to the similarity degree.

FIG. 15 is an example in which, for example, a standing pose with the left hand raised is set as a reference pose. In such a case, a person standing with his/her left hand raised is determined to be in a normal state, and a person sitting and a person standing with his/her right hand raised are determined to be in an abnormal state. Since the feature amount acquired by normalizing the orientation is being used, a person standing with his/her left hand raised in a state of facing backward in the image is also determined to be in a normal state.

As described above, in the present example embodiment, the skeleton structure of the person is detected from the reference pose setting image, and the feature amount of the detected skeleton structure is aggregated and set as the feature amount of the reference pose. Further, the state of the target person is detected by calculating the similarity degree between the feature amount of the reference pose and the feature amount of the skeleton structure of the target person. Thus, a reference pose serving as a reference can be set even for a state of a person that is difficult to define, and such a state of a person can be detected. For example, a person in an abnormal state can be detected using the reference pose as a normal state.

Further, in the present example embodiment, the state of the target person is detected by setting the reference pose by using the orientation dependence-reduced feature amount of the person and calculating the similarity degree with the orientation dependence-reduced feature amount of the target person. For example, as the orientation dependence-reduced feature amount, the feature amount is calculated by normalizing the orientation of the skeleton structure. As a result, the reference pose can be set regardless of the orientation of the person on the image, and the state of the target person can be accurately detected.

Further, in the present example embodiment, the skeleton structure is detected by using the skeleton estimation technique, to thereby detect the setting of the reference pose and the state of the target person. Accordingly, the reference pose can be set without collecting learning data, and the state of the person can be detected.

### Second Example Embodiment

Hereinafter, a second example embodiment is described with reference to the drawings. In the present example embodiment, an example of extracting an orientation dependence-reduced feature amount by using a feature space of a feature amount being invariant to the orientation is described.

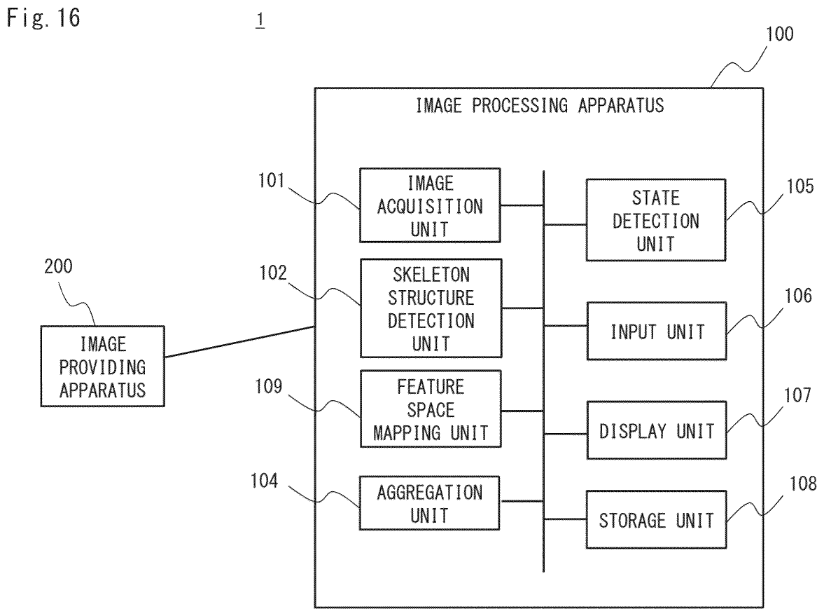

FIG. 16 illustrates a configuration example of an image processing apparatus 100 according to the present example embodiment. As illustrated in FIG. 16, the image processing apparatus 100 according to the present example embodiment includes a feature space mapping unit 109 instead of the feature amount extraction unit 103 as compared with the configuration of the first example embodiment. Other configurations are similar to those of the first example embodiment.

The feature space mapping unit 109 maps a two-dimensional skeleton structure (pose) detected from an image to a feature space, and generates (extracts) an orientation-invariant feature amount being invariant to the orientation of a pose of a person. In the present example embodiment, by using the feature amount space of the orientation-invariant feature amount, a feature amount (orientation dependence-reduced feature amount) in which dependence on the orientation of the skeleton (pose) of the person is reduced is extracted.

For example, the feature space mapping unit 109 may generate an orientation-invariant feature amount in the feature space from the skeleton structure by employing a feature amount extraction model using machine learning. By using the feature amount extraction model which has learned the relation between the skeleton structure of various orientations and the feature amount on the feature space, the skeleton structure can be mapped to the orientation-invariant feature amount on the feature space.

Note that the feature amount extraction model that receives an image may generate (extract) a feature amount of a pose of a person included in an image directly from the image. That is, the function of a skeleton structure detection unit 102 and the function of the feature space mapping unit 109 may be achieved by the feature amount extraction model. For example, a feature amount extraction model which has learned the relation between an image of a person in various orientations and poses and a feature amount in a feature space may be used to perform mapping on the orientation-invariant feature amount in the feature space from the image of the person.

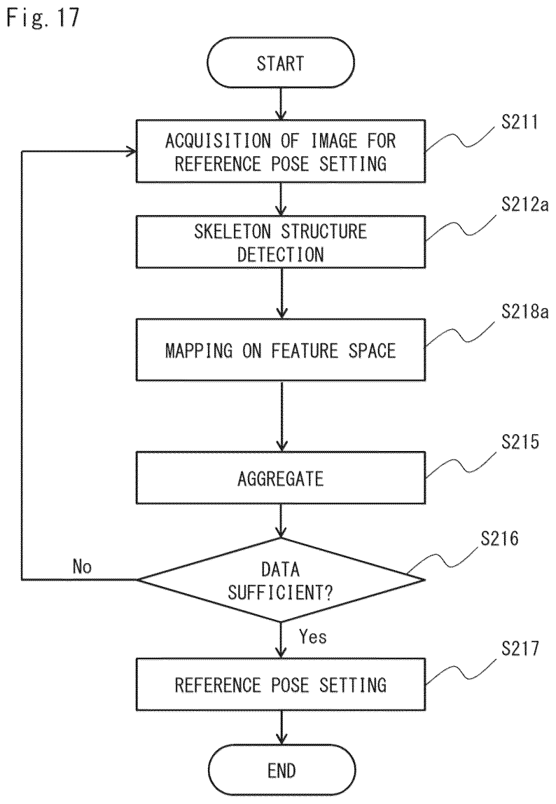

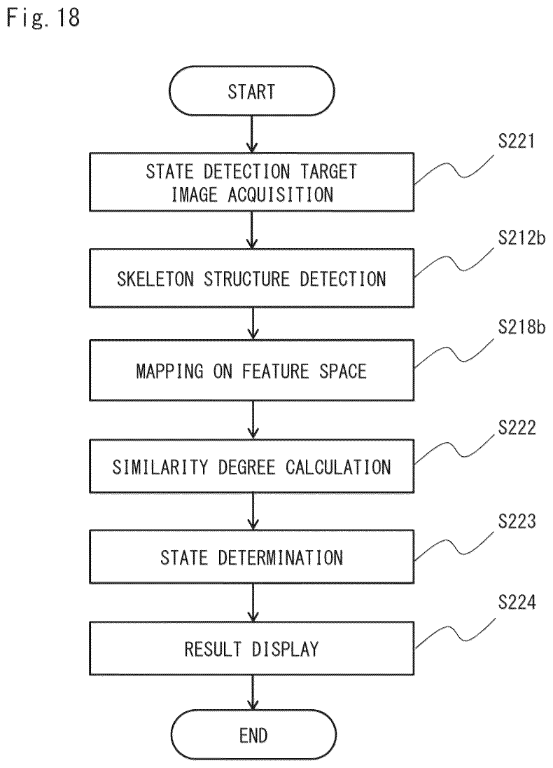

FIGS. 17 to 18 illustrate an operation (image processing method) of the image processing apparatus 100 according to the present example embodiment. The overall operation flow of the image processing apparatus 100 is similar to that of the first example embodiment illustrated in FIG. 4. FIG. 17 illustrates the flow of reference pose setting processing (S201) according to the present example embodiment, and FIG. 18 illustrates the flow of state detection processing (S202) according to the present example embodiment.

First, in the reference pose setting processing (S201), as illustrated in FIG. 17, the image processing apparatus 100 acquires a reference pose setting image (S211), and detects a skeleton structure of the person, based on the acquired reference pose setting image (S212a), similarly to the first example embodiment.

Subsequently, the image processing apparatus 100 maps the skeleton structure of the person detected from the reference pose setting image to a feature space (S218a). The feature space mapping unit 109 maps the skeleton structure of the person detected from the reference pose setting image to the feature space by using, for example, a feature amount extraction model, and generates an orientation-invariant feature amount.

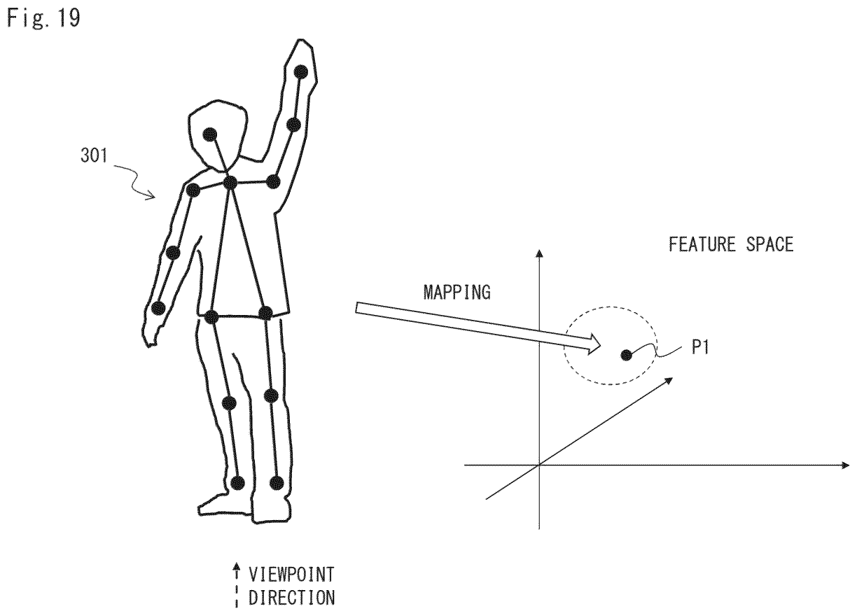

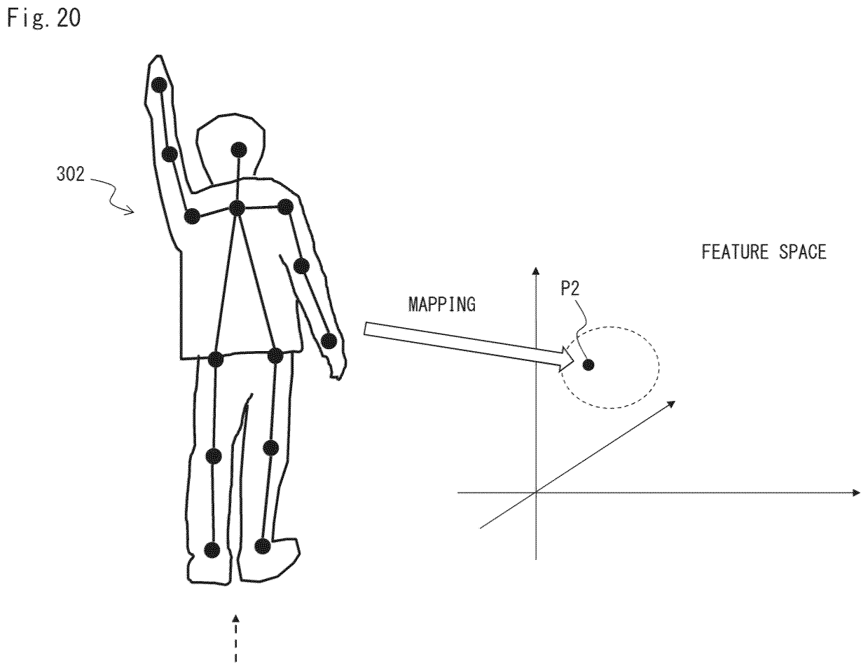

FIGS. 19 and 20 illustrate an example of mapping a skeleton structure to a feature space. FIG. 19 is an example of using an image acquired by capturing a person standing with his/her left hand raised from diagonally front to the left, similarly to FIG. 8. In such a case, a human body model 301 detected from the image faces the left front side (lower left side) on the two-dimensional image relative to the captured viewpoint direction (imaging direction). The feature space mapping unit 109 maps the skeleton structure of the human body model 301 to the feature space by using the feature amount extraction model, and generates an orientation-invariant feature amount P1. For example, the orientation-invariant feature amount P1 is indicated by coordinates on the feature space. The number of dimensions and the like of the feature space are not particularly limited.

FIG. 20 is an example of using an image acquired by capturing a person standing with his/her left hand raised from obliquely behind the right, similarly to FIG. 9. In such a case, a human body model 302 detected from the image faces the right rear side (upper right side) on the two-dimensional image relative to the captured viewpoint direction (imaging direction). The feature space mapping unit 109 maps the skeleton structure of the human body model 302 to the feature space by using the feature amount extraction model, and generates an orientation-invariant feature amount P2. The human body model 301 in FIG. 19 faces the left front side on the image, and the human body model 302 in FIG. 20 faces the right rear side on the image, but the orientation-invariant feature amounts P1 and P2 are close positions in the feature space.

Subsequently, the image processing apparatus 100 aggregates a plurality of feature amounts (orientation-invariant feature amounts) of the skeleton structure extracted in the feature space (S215). Until sufficient data is acquired (S216), the image processing apparatus 100 repeats the processing from the image acquisition to the aggregation of the feature amount of the skeleton structure (S211 to S215), and sets the aggregated feature amount as the feature amount of the reference pose (S217).

The aggregation method of the aggregation unit 104 is similar to that of the first example embodiment. For example, the aggregation unit 104 calculates an average of a plurality of orientation-invariant feature amounts in the feature space, and sets the calculated average orientation-invariant feature amount as the feature amount of the reference pose.

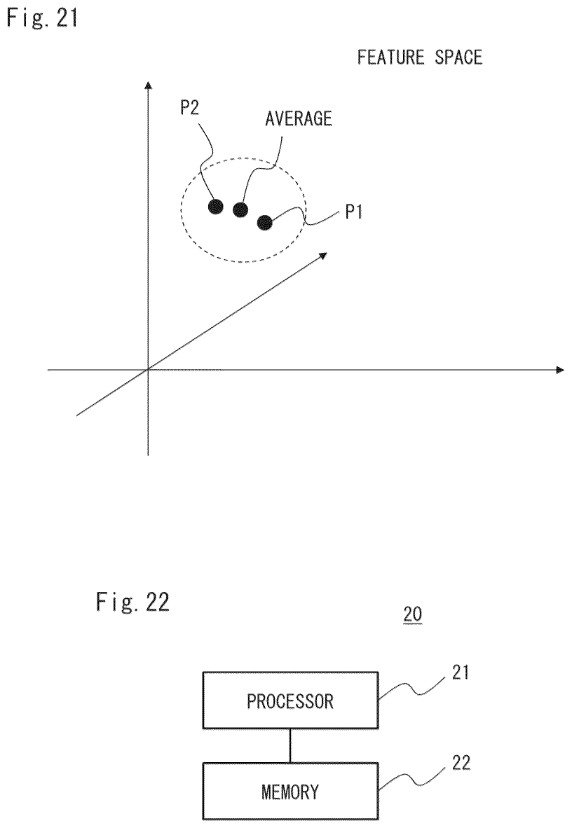

FIG. 21 illustrates an example in which an average of a plurality of orientation-invariant feature amounts is set as a reference pose. For example, the aggregation unit 104 acquires, as an average of the orientation-invariant feature amount P1 of the human body model 301 and the orientation-invariant feature amount P2 of the human body model 302, coordinates of the middle (center) of the invariant feature amount P1 and the invariant feature amount P2 in the feature space, and sets the feature amount of the acquired coordinates as the feature amount of the reference pose.

Next, in the state detection processing (S202), as illustrated in FIG. 18, the image processing apparatus 100 acquires the state detection target image (S221) and detects the skeleton structure of the person in the state detection target image (S212b), similarly to the first example embodiment. Then, the image processing apparatus 100 maps the skeleton structure of the detected person to the feature space similarly to the case of setting the reference pose (S218b). The feature space mapping unit 109 maps the skeleton structure of the person detected from the state detection target image to the feature space by using, for example, the feature amount extraction model, and generates an orientation-invariant feature amount.

Subsequently, similarly to the first example embodiment, the image processing apparatus 100 calculates the similarity degree between the reference pose and the pose of the target person (S222), determines the state of the target person, based on the similarity degree (S223), and displays the determination result (S224). A state detection unit 105 calculates the similarity degree between the orientation-invariant feature amount of the reference pose stored in a storage unit 108 in S217 and the orientation-invariant feature amount of the pose (skeleton structure) of the target person extracted in S218b. The state detection unit 105 calculates the similarity degree, based on the distance between the orientation-invariant feature amount of the reference pose and the orientation-invariant feature amount of the pose of the target person, and determines the state of the target person, based on the calculated similarity degree.

As described above, in the present example embodiment, the orientation-invariant feature amount acquired by mapping the skeleton structure to the feature space is being used as the orientation dependence-reduced feature amount of a person. Even in such a case, similarly to the first example embodiment, the reference pose can be set regardless of the orientation of the pose of the person on the image, and the state of the target person can be accurately detected.

The present disclosure is not limited to the above-described example embodiments, and may be appropriately modified without departing from the scope of the present disclosure.

Each configuration in the above-described example embodiments is configured by hardware or software, or both, and may be configured by one piece of hardware or software, or may be configured by a plurality of pieces of hardware or software. Each device and each function (processing) may be implemented by a computer 20 including a processor 21 such as a central processing unit (CPU) and a memory 22 being a storage device, as illustrated in FIG. 22. For example, a program for performing the method (image processing method) according to the example embodiments may be stored in the memory 22, and each function may be implemented by executing the program stored in the memory 22 by the processor 21.

Such programs include a set of instructions (or software codes) that, when loaded onto a computer, causes the computer to execute one or more of the functions described in the example embodiments. The programs may be stored in a non-transitory computer-readable medium or in a tangible storage medium. By way of example, and not limitation, the computer-readable media or the tangible storage media include a random-access memory (RAM), a read-only memory (ROM), a flash memory, a solid-state drive (SSD), or other memory technologies, a CD-ROM, a digital versatile disc (DVD), a Blu-ray (registered trademark) disk, or other optical disk storages, and a magnetic cassette, a magnetic tape, a magnetic disk storage or other magnetic storage devices. The programs may be transmitted via a transitory computer readable medium or via a communication medium. By way of example, and not limitation, the transitory computer-readable media or the communication media include an electrical, optical, acoustic, or other forms of propagated signals.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure.

Some or all of the above-described example embodiments may be described as the following supplementary notes, but are not limited thereto.

### (Supplementary Note 1)

An image processing system including:
an acquisition means for acquiring pose information based on estimation of a pose of a person included in a first image;
an extraction means for extracting, based on the acquired pose information, an orientation dependence-reduced feature amount in which dependence of the pose information on a pose orientation is reduced; and
a setting means for setting the extracted orientation dependence-reduced feature amount as a feature amount of a reference pose for detecting a state of a target person included in a second image.

### (Supplementary Note 2)

The image processing system according to supplementary note 1, wherein the extraction means normalizes the pose orientation of the pose information to a predetermined direction, and extracts a feature amount of the orientation-normalized pose information as the orientation dependence-reduced feature amount.

### (Supplementary Note 3)

The image processing system according to supplementary note 1, wherein the extraction means maps the pose information to a feature space of a feature amount invariant to orientation, and extracts the mapped feature amount on the feature space as the orientation dependence-reduced feature amount.

### (Supplementary Note 4)

The image processing system according to any one of supplementary notes 1 to 3, wherein the setting means aggregates the extracted orientation dependence-reduced feature amount for each predetermined unit, and sets the feature amount of the reference pose, based on the aggregation result.

### (Supplementary Note 5)

The image processing system according to supplementary note 4, wherein the setting means calculates a statistical value of the orientation dependence-reduced feature amount for each of the predetermined units.

### (Supplementary Note 6)

The image processing system according to supplementary note 4, wherein the setting means clusters the orientation dependence-reduced feature amount for each of the predetermined units, and sets the feature amount of the reference pose, based on the clustered result.

### (Supplementary Note 7)

The image processing system according to any one of supplementary notes 4 to 6, wherein the setting means aggregates the orientation dependence-reduced feature amount for each of the first images or for each predetermined region in the first image.

### (Supplementary Note 8)

The image processing system according to any one of supplementary notes 4 to 7, wherein the setting means aggregates the orientation dependence-reduced feature amount for each predetermined time period in which the first image is captured.

### (Supplementary Note 9)

The image processing system according to any one of supplementary notes 1 to 8, further including a state detection means for detecting a state of a target person included in the second image, based on the set feature amount of the reference pose.

### (Supplementary Note 10)

The image processing system according to supplementary note 9, wherein
the acquisition means acquires pose information based on estimation of the pose of the target person included in the second image,
the extraction means extracts the orientation dependence-reduced feature amount of the pose of the target person, based on the pose information acquired from the second image, and
the state detection means detects the state of the target person, based on a similarity degree between the feature amount of the reference pose and the orientation dependence-reduced feature amount of the pose of the target person.

### (Supplementary Note 11)

The image processing system according to supplementary note 10, wherein the state detection means calculates the similarity degree, based on a weight set for each part in the reference pose.

### (Supplementary Note 12)

The image processing system according to supplementary note 10 or 11, wherein
the feature amount of the reference pose and the orientation dependence-reduced feature amount of the pose of the target person each include feature amounts of a plurality of poses, and
the state detection means calculates a similarity degree of the feature amounts of the plurality of poses.

### (Supplementary Note 13)

The image processing system according to any one of supplementary notes 10 to 12, wherein
the feature amount of the reference pose and the orientation dependence-reduced feature amount of the pose of the target person each include time-series feature amounts extracted based on a plurality of images consecutive in time series, and
the state detection means calculates a similarity degree of the time-series feature amounts.

### (Supplementary Note 14)

The image processing system according to any one of supplementary notes 10 to 13, wherein the state detection means detects whether the target person is in an abnormal state, based on the similarity degree by using the reference pose as a normal state pose.

### (Supplementary Note 15)

An image processing method including:
acquiring pose information based on estimation of a pose of a person included in a first image;
extracting, based on the acquired pose information, an orientation dependence-reduced feature amount in which dependence of the pose information on a pose orientation is reduced; and
setting the extracted orientation dependence-reduced feature amount as a feature amount of a reference pose for detecting a state of a target person included in a second image.

### (Supplementary Note 16)

The image processing method according to supplementary note 15, further including normalizing the pose orientation of the pose information to a predetermined direction, and extracting a feature amount of the orientation-normalized pose information as the orientation dependence-reduced feature amount.

### (Supplementary Note 17)

The image processing method according to supplementary note 15, further including mapping the pose information to a feature space of a feature amount invariant to orientation, and extracting the mapped feature amount on the feature space as the orientation dependence-reduced feature amount.

### (Supplementary Note 18)

A non-transitory computer-readable medium storing an image processing program for causing a computer to execute processing of:
acquiring pose information based on estimation of a pose of a person included in a first image;
extracting, based on the acquired pose information, an orientation dependence-reduced feature amount in which dependence of the pose information on a pose orientation is reduced; and
setting the extracted orientation dependence-reduced feature amount as a feature amount of a reference pose for detecting a state of a target person included in a second image.

### (Supplementary Note 19)

The non-transitory computer-readable medium according to supplementary note 18, further including normalizing the pose orientation of the pose information to a predetermined direction, and extracting a feature amount of the orientation-normalized pose information as the orientation dependence-reduced feature amount.

### (Supplementary Note 20)

The non-transitory computer-readable medium according to supplementary note 19, further including mapping the pose information to a feature space of a feature amount invariant to orientation, and extracting the mapped feature amount on the feature space as the orientation dependence-reduced feature amount.

### REFERENCE SIGNS LIST

1, 10 IMAGE PROCESSING SYSTEM
11 ACQUISITION UNIT
12 EXTRACTION UNIT
13 SETTING UNIT
20 COMPUTER
21 PROCESSOR
22 MEMORY
100 IMAGE PROCESSING APPARATUS
101 IMAGE ACQUISITION UNIT
102 SKELETON STRUCTURE DETECTION UNIT
103 FEATURE AMOUNT EXTRACTION UNIT
104 AGGREGATION UNIT
105 STATE DETECTION UNIT
106 INPUT UNIT
107 DISPLAY UNIT
108 STORAGE UNIT
109 FEATURE SPACE MAPPING UNIT
200 IMAGE PROVIDING APPARATUS

What is claimed is:

1. An image processing system comprising:
at least one memory storing instructions, and at least one processor configured to execute the instructions stored in the at least one memory to;
acquire pose information based on estimation of a pose of a person included in a first image;
extract, based on the acquired pose information, an orientation dependence-reduced feature amount in which dependence of the pose information on a pose orientation is reduced; and
set the extracted orientation dependence-reduced feature amount as a feature amount of a reference pose for detecting a state of a target person included in a second image.

2. The image processing system according to claim 1, wherein the at least one processor is further configured to execute the instructions stored in the at least one memory to:
normalize the pose orientation of the pose information to a predetermined direction; and
extract a feature amount of the orientation-normalized pose information as the orientation dependence-reduced feature amount.

3. The image processing system according to claim 1, wherein the at least one processor is further configured to execute the instructions stored in the at least one memory to:
map the pose information to a feature space of a feature amount invariant to orientation; and
extract the mapped feature amount on the feature space as the orientation dependence-reduced feature amount.

4. The image processing system according to claim 1, wherein the at least one processor is further configured to execute the instructions stored in the at least one memory to:
aggregate the extracted orientation dependence-reduced feature amount for each predetermined unit; and
set the feature amount of the reference pose, based on the aggregation result.

5. The image processing system according to claim 4, wherein the at least one processor is further configured to execute the instructions stored in the at least one memory to calculate a statistical value of the orientation dependence-reduced feature amount for each of the predetermined units.

6. The image processing system according to claim 4, wherein the at least one processor is further configured to execute the instructions stored in the at least one memory to:
cluster the orientation dependence-reduced feature amount for each of the predetermined units; and
set the feature amount of the reference pose, based on the clustered result.

7. The image processing system according to claim 4, wherein the at least one processor is further configured to execute the instructions stored in the at least one memory to aggregate the orientation dependence-reduced feature amount for each of the first images or for each predetermined region in the first image.

8. The image processing system according to claim 4, wherein the at least one processor is further configured to execute the instructions stored in the at least one memory to aggregate the orientation dependence-reduced feature amount for each predetermined time period in which the first image is captured.

9. The image processing system according to claim 1, wherein the at least one processor is further configured to execute the instructions stored in the at least one memory to detect a state of a target person included in the second image, based on the set feature amount of the reference pose.

10. The image processing system according to claim 9, wherein
the at least one processor is further configured to execute the instructions stored in the at least one memory to:
acquire pose information based on estimation of the pose of the target person included in the second image;
extract the orientation dependence-reduced feature amount of the pose of the target person, based on the pose information acquired from the second image; and
detect the state of the target person, based on a similarity degree between the feature amount of the reference pose and the orientation dependence-reduced feature amount of the pose of the target person.

11. The image processing system according to claim 10, wherein the at least one processor is further configured to execute the instructions stored in the at least one memory to calculate the similarity degree, based on a weight set for each part in the reference pose.

12. The image processing system according to claim 10, wherein
the feature amount of the reference pose and the orientation dependence-reduced feature amount of the pose of the target person each include feature amounts of a plurality of poses, and
the at least one processor is further configured to execute the instructions stored in the at least one memory to calculate a similarity degree of the feature amounts of the plurality of poses.

13. The image processing system according to claim 10, wherein
the feature amount of the reference pose and the orientation dependence-reduced feature amount of the pose of the target person each include time-series feature amounts extracted based on a plurality of images consecutive in time series, and
the at least one processor is further configured to execute the instructions stored in the at least one memory to calculate a similarity degree of the time-series feature amounts.

14. The image processing system according to claim 10, wherein the at least one processor is further configured to execute the instructions stored in the at least one memory to detect whether the target person is in an abnormal state, based on the similarity degree by using the reference pose as a normal state pose.

15. An image processing method comprising:
acquiring pose information based on estimation of a pose of a person included in a first image;
extracting, based on the acquired pose information, an orientation dependence-reduced feature amount in which dependence of the pose information on a pose orientation is reduced; and
setting the extracted orientation dependence-reduced feature amount as a feature amount of a reference pose for detecting a state of a target person included in a second image.

16. The image processing method according to claim 15, further comprising;
normalizing the pose orientation of the pose information to a predetermined direction; and
extracting a feature amount of the orientation-normalized pose information as the orientation dependence-reduced feature amount.

17. The image processing method according to claim 15, further comprising:
mapping the pose information to a feature space of a feature amount invariant to orientation; and
extracting the mapped feature amount on the feature space as the orientation dependence-reduced feature amount.

18. A non-transitory computer-readable medium storing an image processing program for causing a computer to execute processing of:
acquiring pose information based on estimation of a pose of a person included in a first image;
extracting, based on the acquired pose information, an orientation dependence-reduced feature amount in which dependence of the pose information on a pose orientation is reduced; and
setting the extracted orientation dependence-reduced feature amount as a feature amount of a reference pose for detecting a state of a target person included in a second image.

19. The non-transitory computer-readable medium according to claim 18, further comprising:
normalizing the pose orientation of the pose information to a predetermined direction; and
extracting a feature amount of the orientation-normalized pose information as the orientation dependence-reduced feature amount.

20. The non-transitory computer-readable medium according to claim 18, further comprising:
mapping the pose information to a feature space of a feature amount invariant to orientation; and
extracting the mapped feature amount on the feature space as the orientation dependence-reduced feature amount.
